(19) United States
(12) Patent Application Publication
(10) Pub. No.: US 2011/0008586 A1
(43) Pub. Date: Jan. 13, 2011

(54) INSULATIVE CONSTRUCTION MATERIAL

(76) Inventor: Michael S. Lesniak, Romulus, MI (US)

Correspondence Address: CARGILL & ASSOCIATES, P.L.L.C., 56 MACOMB PLACE, MT. CLEMENS, MI, 48043, US

(21) Appl. No.: 12/835,642

(22) Filed: Jul. 13, 2010

Related U.S. Application Data
(60) Provisional application No. 61/225,098, filed on Jul. 13, 2009.

(51) Int. Cl. E04C 2/284; E04B 1/78; B32B 29/00

(52) U.S. Cl. 428/188; 52/741.4; 428/537.7

(57) ABSTRACT

Disclosed is a retrofit insulation system and method of installing same for use in existing structures. Included is a multi-layer insulative construction material, comprising at least one layer of drywall having a front side intended to face the interior of a room and a back side which will be adhered to a second layer of material. Generally an adhesive layer selected from the group consisting of spray on adhesive, roll-on adhesive, brush-on adhesive, dipping adhesive, and any combination thereof is used to fasten a second layer of at least one layer of insulation material. This yields an insulative construction material that is capable of being installed over an existing wall to increase the insulative value of the wall.

### CROSS REFERENCES TO RELATED APPLICATIONS

This application claims the benefit under 35 U.S.C. 119(e) of U.S. Provisional Application No. 61/225,098 filed on Jul. 13, 2009.

### BACKGROUND OF THE INVENTION

1. Field of the Invention

This patent application relates to the construction industry, and more particularly relates to more insulation construction requirements from President Obama's energy saving decree.

2. Background of the Invention

In these changing economic times, new home construction has nearly come to a dead halt. Remodeling has become an exercise in insulating presently existing homes, with an eye to energy conservation. President Obama has asked for bail out monies for individuals and businesses to insulate their homes in order to conserve energy. In that regard, new inventions have come forth for saving energy, as well as new, more stringent guidelines for home construction and remodeling.

For example, traditional homes have had requirements for insulation values in the walls to be R-13, while the new guidelines will be required to be an R-21 value in order to conserve energy. Furthermore, in the remodeling industry, insulation designed for energy conservation will also be desirable to provide an R-21 value for the walls.

Traditionally, homes were made with two-by-four stud construction, and then conventional OSB boards were placed on the outside of the home, and were covered with siding, brick, or whatever exterior treatment the homeowner desired. Inside the home, drywall was hung on the two-by-four construction, the joints between the drywall were taped, and insulation was placed in the cavities created by the box sided in by the two-by-fours, the OSB board, and the drywall. However, this construction merely yielded an R-13 value, if the homeowner was lucky.

In order to achieve the R-21 value that is now recommended by President Obama, to save on energy, most home builders have decided that they will now be required to utilize a two-by-six construction for the stud framing for the home. They have decided that the use of more insulation between the studs is the proper way to achieve the R-21 value recommended by our President. However, environmentally, it would save more trees if we could continue to utilize the two-by-four construction of the home, which is generally, sufficiently sturdy for most climates and locations, and to provide greater insulation while still utilizing the two-by-four skeleton.

Therefore, it would be desirable to have an aspect of an invention to provide an additional insulation construction device which would utilize the two-by-four construction, and still provide greater insulative value, i.e. R-21 wall values.

### SUMMARY OF THE INVENTION

It is a first aspect of the present invention to provide a new insulative construction material that includes a multi-layer insulative structure, including a bonded piece of drywall adhered to at least one piece of insulation material, especially a sheet of foam insulation. Such a multi-layer piece of insulated drywall would be able to be adhered over an existing two-by-four construction, thereby providing a greater insulative value than the drywall by itself. This new construction material will have additional insulation, in order to create at least an insulation value R-21 wall from a pre-existing R-13 wall.

A second aspect of the present invention includes a method for an existing homeowner to install the present invention around an entire room's interior walls, including the ceiling, with my new construction material, so as to create at least R-21 insulation values for all the interior walls and the ceiling. In essence, the interior rooms of a building would be “skinned” with this new construction material, and the room would merely be one inch to one and a half inches smaller (1″ to 1½″) in each direction, but it could be more depending on the thickness of the insulation layer), which would be the total depth of the second sheet of drywall with the foam adhered to the back, installed over the existing drywall in a room.

It is envisioned by the present inventor that the floor would remain as it is, although after the multi-layer insulative drywall sheets are installed, the floor moldings would merely be brought closer into the room.

In the following paragraphs, details will be given of numerous possible layers of drywall, along with their alternatives, bonded to each of the types of insulation. This includes various foams which are in various aspects of the invention, along with all of the specifics and generic formats for possible layers are attached thereto. Further, descriptions will be given of possible additional optional layers which may be utilized for varying specific aspects and purposes, i.e. as a vapor barrier, conductive barrier, or as reinforcement for the walls to tighten and strengthen the wall.

### BRIEF DESCRIPTION OF THE DRAWINGS

For a further understanding of the nature and advantages of the expected scope and various embodiments of the present invention, reference shall be made to the following detailed description, and shall be taken in conjunction with the accompanying drawings, in which like parts are given the same reference numerals, and wherein:

FIG. 1 is a two layer insulative construction material made in accordance with the present invention;

FIG. 2 is a three layer insulative construction material made in accordance with the present invention;

FIG. 3 illustrates a multi-layer coinsulative construction material with cavities formed into the back side;

FIG. 4 shows a perspective elevational view of an extra depth door molding for use in conjunction with the multi-layer insulative construction material; and

FIG. 5 shows a perspective elevational view of an extra depth electrical junction box for use in conjunction with the multi-layer insulative construction material.

### DETAILED DESCRIPTION OF THE INVENTION

The present invention is a multi-layer insulative material, including at least two layers of material, i.e. at least a first sheet of drywall adhered to at least a second sheet of insulation material. Additional layers made be adhered or fastened in any suitable fashion across any portion of the surface for enhancing the present invention by adding more desirable material properties, such as fire retardants, sound deadening, or any other desirable property. Other aspects may include partial sheets of insulation or other materials adhered to a full sheet of drywall, and then additional materials could be oozed into the openings or cavities created by the use of a partial sheet. Such a material might be a liquid-to-foam material to fill all the cavities with a foam insulation material, or portions thereof. This material could also be used to adhere the new insulative constructive material to the pre-existing wall.

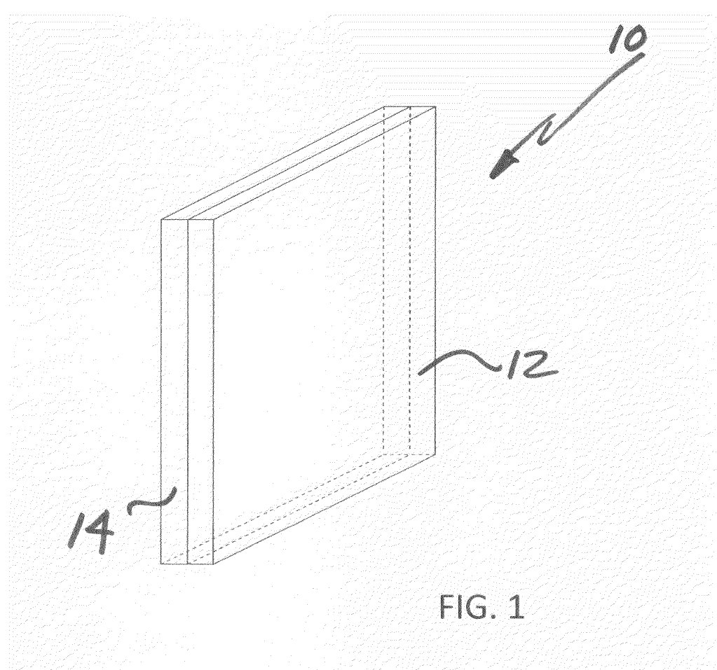

Looking first at FIG. 1, there is shown a first aspect of the present invention with 2 layers of material. This composite structure, generally denoted by the numeral 10, includes a first layer of drywall 12 bonded or fastened to a second layer of insulation 14. These materials are commercially available as more fully described herein below.

An adhesive, such as various 3M® branded adhesives, commercially available from 3M Corporation of Minnesota, may be used to adhere the two layers together, or the two layers may be adhered by laminating them together with the best currently available laminating process, which may become updated based upon current and future improved methods. Any suitable adhesive may be used, so long as it does not create any safety issues. Such an adhesive may be selected from the group consisting of spray-on adhesive, roll-on adhesive, brush-on adhesive, dipping adhesive, and any combination thereof. Most likely, a spray-on adhesive will work best, but any of these methods are suitable under varying circumstances. Regardless of how the adhesive gets applied, the layers of drywall and insulation shall be adhered together.

Further, the at least two layers can be fastened together using any suitable fastener means such as double sided tape, clips around the edges, rivets, screws, bolts, nail gun nails, or the like.

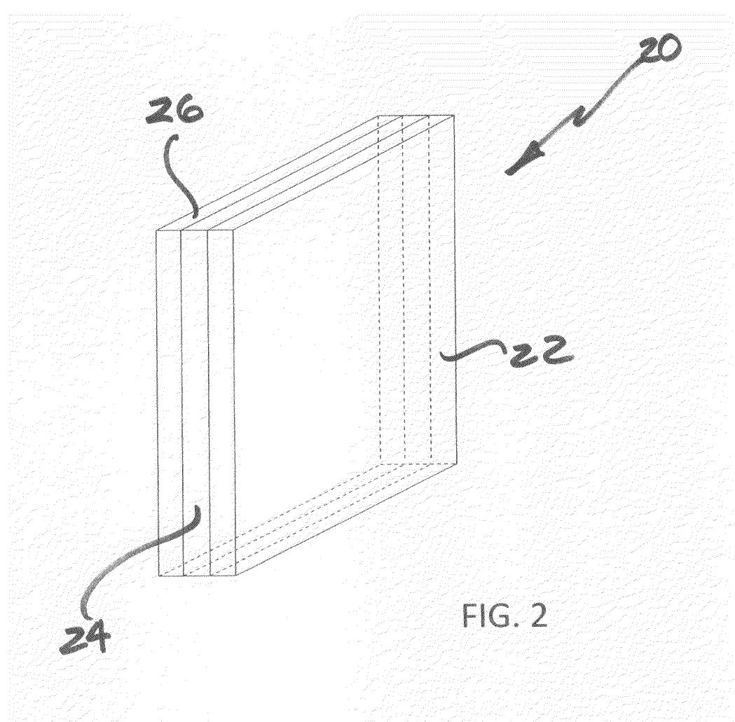

Looking next to FIG. 2, there is shown a second aspect of the invention, where the present invention utilizes at least three (3) layers, generally denoted by the numeral 20, including a sheet of drywall 22, a sheet of insulation 24, such as a layer of Styrofoam® sheet, and a vapor barrier layer 26, such as metal foil, corrugated foil of various types, or polyurethane.

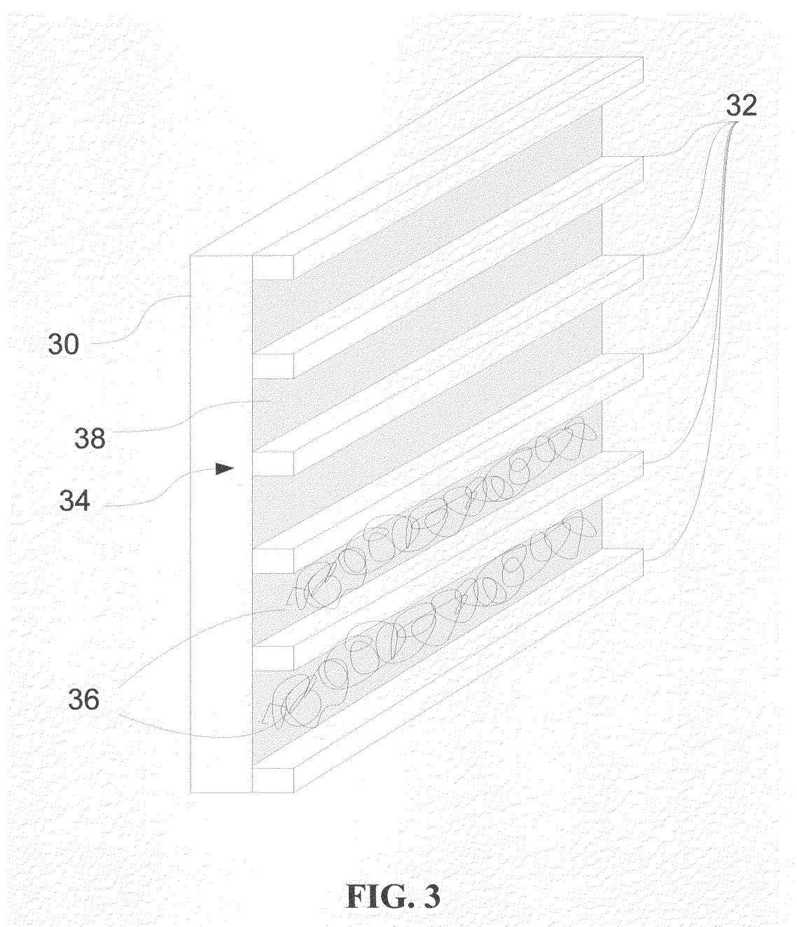

Referring now to FIG. 3, there is shown a third aspect of the multi-layer material invention, where a drywall layer 30 is adhered to multiple strips of insulation 32. Adhesive may be applied to the faces 34 of the strips, and this assembly is pressed against a pre-existing wall. Thereafter, liquid-to-foam insulation 36 may be sprayed into the cavities 38 created by the strips 32 to form a solid insulation backing for the drywall layer. Any suitable cavity design may be utilized and created merely by subtracting material from the backside of drywall layer 30. For instance, if a computer conduit needs to be hidden behind the new drywall composite wall, a cavity can be created in the insulation layer to accommodate the conduit. Then, foam spray insulation can be used to fill in the remainder of the conduit cavity.

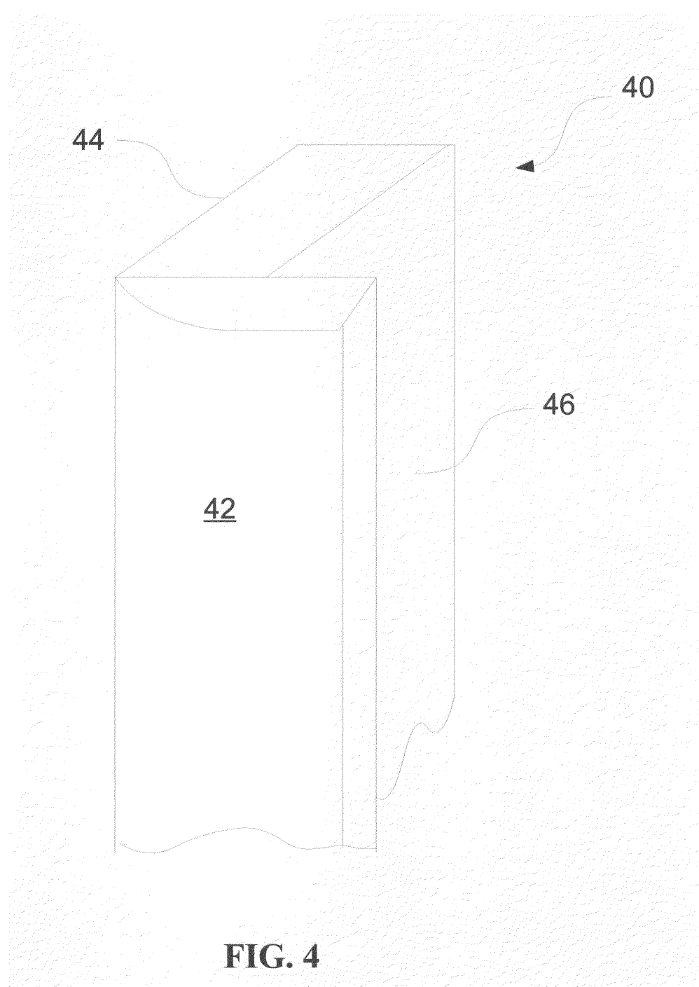

FIG. 4 illustrates a custom made door molding that can be used advantageously with the insulated drywall invention, as it has an extra depth component to accommodate the increased wall thickness. The new molding is generally denoted by the numeral 40, and includes a standard face portion of beauty molding 42, with a backstroke portion 44. The increased depth wall jam portion 46 is deep enough to cover the additional wall thickness created by the new insulative construction material being added to the existing wall.

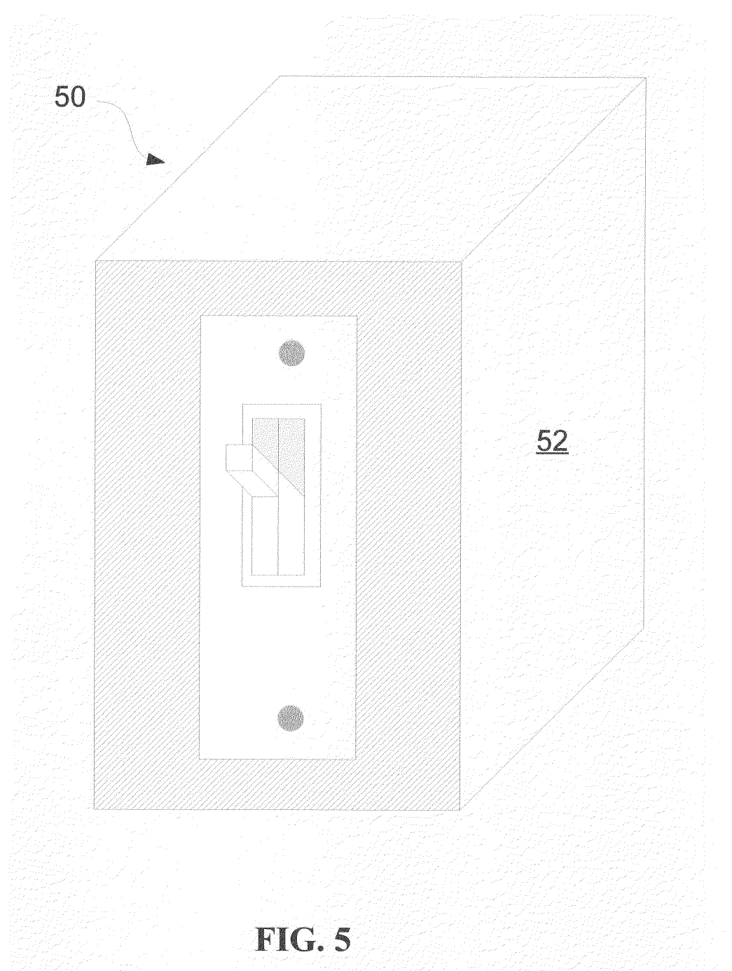

FIG. 5 likewise illustrates a new electrical junction box generally denoted by the numeral 50. The interior walls 52 of the junction box have an increased dimension as it has an extra depth component to the junction box 50 to accommodate the increased wall thickness 52.

### 1. Material Components

In the manufacture of a multi-layer insulative construction material, there are many possibilities. Each layer can be selected for its individual virtues, and a composite construction can be constructed to provide the maximum benefits desired. In that regard, the following is a partial list of possible layers that can be adhered to one another to prepare a multi-layer insulation material made in accordance with the present invention for several aspects of the construction covering, either in combinations of two or more layers, or individual layers stacked and secured by any known means.

The generically referenced materials described as drywall hereinbelow, such as Gypsum Board can be purchased at local building supply and contractor outlets. They may be commercially available under various names, such as: Sheet Rock®, Fiber Rock®, Aqua Tough® Sheet Rock, Mold Tough® Sheet, Very High Impact, Abuse Resistant, or Fire Code-C core; and Plaster Base Drywall, such as plaster base, some of which are registered trademarks of, and commercially available from U.S.G CORPORATION of Chicago, Ill. Any suitable drywall material may be utilized. The above listing is merely illustrative, and shall not be used to limit the scope of the present invention, but may rather be used to provide examples of suitable materials.

In order to provide special properties, such as sound deadening or fire resistance to the multi-layer insulation material made in accordance with the present invention, in various aspects of the invention, another possible layer would be special gypsums, such as: Sound Break XP® Board, Gold Bond® Board, Grid Marx®, eXP Extended Exposure Shaftliner, eXP Extended Exposure Sheathing, Hi-Impact XP Gypsum Board, Hi-Abuse Gypsum Board, XP Gypsum Board, Shaftliner XP, such as: 1″ Gold Fire® Shield, Gold Bond® Gypsum Board, Gold Bond Fire Shield®, C-Gypsum Board, such as: Gold Bond Fire Shield®, Board, such as: ¼″ High Flex Gypsum, Sheathing, such as: Gold Bond Gypsum®, Shaftliner, such as: 1″ Gold Bond® Fire-Shield, Soffit Board, such as: Gold Bond® Exterior, Ceiling Board, such as: ½″ High Strength, Gypsum Board, such as: Gold Bond® Foil Back, Panels, such as: Gridstone® Gypsum Ceiling, Ceiling Panels, such as: Gridstone® Cleanroom, Wallboard, such as: Gold Bond Sta Smooth®, Durabase® Gypsum Board, Gypsum Board, such as: Durasan® Pre-finished, or Plaster Base, such as Kal Kore®, Hi-Abuse Kal Kore®, some of which are registered trademarks of, and all of which are commercially available from NATIONAL GYPSUM PROPERTIES, LLC of Charlotte, N.C.

Looking now to other types of suitable drywall materials, including Gypsum, the following materials may find utility in the present invention, such as Eagle Rock® Gypsum Wall Board, Fire Block Type X®, Fire Block Type C®, M-Block®, Aqua Block®, Smooth Rock®, Interior Ceiling, Exterior Gypsum Sheathing, Veneer Gypsum Wall Board, Eagle Rock®Laminate Gypsum Board, registered trademarks of, and commercially available from AMERICAN GYPSUM COMPANY of Dallas, Tex.

Yet another type of Gypsum may be useful in some aspects of the present invention, such as Gyproc® Wall Board, Gyproc® Wall Board Duplex, Gyproc Wall Board 4TE®, Gyproc Handiboard®, Gyproc Handiboard Duplex®, Gyproc Soundbloc®, Gyproc Soundbloc MR®, Gyproc Soundbloc Rapid MR®, Gyproc Wallboard Ten, Gyproc Plank, Gyproc Tri Line®, Gyproc Fireline®, Gyproc Fireline Duplex®, Gyproc Fireline MR®, Gyproc Coreboard®, Gyproc Duraline®, Gyproc Duraline MR®, Gyproc Ergo 900®, Gyproc Moisture Resistant Plaster Board, such as: Thermaline® Ready Reckoner, Thermaline® Basic, Thermaline® Plus, Thermaline® Super, Thermaline® Platinum, non-registered and registered trademarks of, and commercially available from BRITISH PLASTER BOARD of Parnell, Auckland, New Zealand.

Further, availability of yet more types of gypsum may find utility, such as Tough Rock®, Denshield® Tile Backer, Densguard® Tile Backer, Denglass® Ultra Shaftliner, Dens Fiberglass Mat, Dens Glass® Ext. Sheathing, Dens Deck® Roof Board, Dens Deck Prime Roof iBoard, Dens Deck Duraguard® Roof Board, Densarmor® Plus Impact Resistant, Densarmor® Plus Abuse Resistant, Densarmor Plus High Performance, each a trademark of, and commercially available from GEORGIA-PACIFIC CORPORATION of Atlanta, Ga.

Also possible is gypsum board sold as Pabco Regular Wallboard ⅜″, Pabco Regular Wallboard ½″, Pabco Ceiling Board ½″, Pabco Flame Curb® Type X, Pabco Flame Curb® Type XXX, Pabco Flame Curb® Type Super C, Pabco Water Curb®, Pabco Water Curb® Treated Type X Core, Pabco Ext. Gypsum Soffit Board Type XXX, Pabco Ext. Gypsum Soffit Board Type X, Pabco Gypsum Shaftliner Board Type X, registered trademarks of, and commercially available from PABCO GYPSUM of Newark, Calif. Or, another possibility is gypsum board like Regular Gypsum Board, Stretch 54″ Wide Board, Fire Resistant Gypsum, Comfort Guard® Mold Resistant, Comfort Guard® Sound Deadening, Greenglass® Fiberglass Faced, Structguard® TS Sheathing, Silentguard® Shaftliner, Damage Guard® AR/IR, Span 24 Ceiling Board, Gypsum Sheathing, non-registered and registered trademarks of, and commercially available from TEMPLE INLAND INC. of Austin, Tex.

A further aspect of the present invention can include a layer of Cement Board adhered to drywall with any conventional adhesive, such as: Hardie Backer® Cement Board, and Hardie Backer® 500, registered trademarks of, and commercially available from JAMES HARDIE INTERNATIONAL FINANCE B.V of Mission Viejo, Calif., or Cement Boards, such as Derma Base®, Derma Base® Flex, Derma Base® DEK, sold as registered trademarks of, and commercially available from UNIFIX® INC. (Subsidiary of National Gypsum) of Bromont, Quebec, Canada.

In yet another aspect of the present invention, extruded polystyrene may be adhered to a layer of drywall. Extruded polystyrene, such as Styrofoam, a Registered trademark of, and commercially available by DOW INC. of Midland, Mich., may be useful as a layer, or Fanfold®, Foamular Half Inch, Foamular 150, Foamular 250, Pro Pink® Fanfold, Pro Pink® Fanfold Reflective, insulated sheathing, such as Pro Pink® Reinforced, a registered trademark of, and commercially available from OWENS CORNING of Toledo, Ohio, or Molded Expanded Polystyrene (MEPS); Steer-o-Cell®, a registered trademark of, and commercially available from ARVRON INC. of Grand Rapids, Mich., and commercially available polyisocyanurate (iso board) rigid closed cell or open foams, such as ELFOAM a registered trademark from Elliott Company of Indianapolis, Ind., or another similar type of “iso board” and Polyurethane Foam manufactured by Dyplast Products, LLC, of Miami, Fla. may be added. Further, a layer of recycled blue jeans marketed as Bonded Logic, a trademark owned by and commercially available from Bonded Logic, Inc of Chandler, Ariz. or an insulative layer of Aerogel, a trademark owned by and commercially available from American Aerogel Corp. of Rochester, N.Y., may find utility as an insulator when bonded to a sheet of dry wall. Polyethylene sheeting may also find utility in the present invention, and is commercially available at any Home Depot store.

In order to find further utility as a performance insulative material, yet further aspects of the invention may include at least one additional layer of polyisocyanurate, latex, organic base foam, extended expanded polystyrene, recycled blue jeans, and/or carpet pad insulation.

One more aspect of the present invention may further include a layer of metal foil which can perform as a vapor barrier when adhered to the insulative construction material. The metal foil may also include a heat reflective metallic foil layer to reflect the heat back into the room.

### EXAMPLES

In keeping with compliance of disclosure of various preferred embodiments, any combination of the above mentioned components may be utilized for the present invention. The following are specific examples of various aspects of combinations of layers that may include:

### Example 1

For this example, a conventional ½″ or ⅝″ inch thick drywall sheet (4′×8′) is bonded to a 1″ thick polyisocyanurate rigid board (4′×8′) with a covering of heat reflective metal foil adhered to the face of the polyisocyanurate board. In yet another aspect, this configuration may be made in an offset overlapping manner as to allow the boards to interlock when fixed to a stud wall or ceiling. The R value was rated at least as an R-21 insulative material overall.

### Example 2

A ½″ or ⅝″ inch thick drywall sheet (4′×8′) is bonded to a 1″ thick polystyrene rigid board (4′×8′) using a conventional adhesive, and a covering of heat reflective metal foil was adhered to the polystyrene board. Again, this example could be made in an offset overlapping manner as to allow the boards to interlock when affixed to a stud wall or ceiling. For this example, the R value was rated at least as an R-21 insulative material overall.

### Example 3

A ½″ or ⅝″ inch thick drywall sheet (4′×8′) was bonded to a polyisocyanurate rigid board without the metal foil skin. A conventional spray adhesive was utilized. The R value was rated at least as an R-21 insulative material overall.

### Example 4

A ½″ or ⅝″ inch thick drywall sheet (4′×8′) was bonded to a polystyrene rigid board without the metal foil skin. A conventional spray adhesive was utilized. The R value was rated at least as an R-21 insulative material overall.

### Example 5

A ½″ or ⅝″ inch thick drywall sheet (4′×8′) with just the metal foil covering adhered to the back of the drywall was tested, and the R value was rated at least as an R-21 insulative material overall.

Of course, any of the above examples could have been made of any size smaller sheet for around windows or similar construction instances where a smaller piece might be needed, or if larger sizes are needed, such as 4′×10′ sheets or 4′×12′ to accommodate any type of project requiring larger size board. There is also a possibility of using a ¼ or 3/8 inch drywall in any of the above example specifications. This would help to cut the cost of the conventional building drywall material need to produce panels in accordance with the present invention, where a saving on the cost of raw materials would result, without compromising the insulative value of the multi-layer material of the present invention.

In addition to the sheeted material described hereinabove, the inventor also envisions complementary fixtures and products, including electrical outlet boxes having an extended junction box depth to accommodate the new, additional wall thickness. Extended depth moldings, window casings and floorboards are also envisioned. Heat register casings would also be advantageously extended in the width of the casing to accommodate the new wall thickness. In general, any wall or ceiling mounted device that conventionally extends through conventionally installed drywall sheets would need an increased depth to accommodate the new deeper drywall construction.

For particular applications, such as hurricane construction requirements, additional reinforcements and strength barriers, i.e. for prevention of projectile penetration, may be added to these individual sheets in order to comply with local construction regulations and requirements.

The construction material disclosed by the present application is important in order to help our country's energy policy, and the invention, in its many aspects, addresses many of the environmental concerns in order to help America become energy independent.

### 2. Method of Installation

The method for installing insulative material includes providing a multi-layer insulative material made in accordance with the present invention, and installing full and partial sheets of my insulative material over existing wall coverings to provide further insulation value. Since the addition of such a new material will require the removal and reinstallation of new window and doorway moldings, these moldings should be removed before the new installation of the multi-layer insulation boards are installed. Crown moldings will be able to be re-attached without much, if any, size modification. Electrical outlet coverings and window/doorway moldings that are especially deep socketed, in order to accommodate the new deeper dimension caused by the installation are also part of my invention. These deep socketed accessories will be installed in accordance with the present invention method after the insulative material device has been installed on the walls and ceilings. Unless the floor is re-installed, there will only be a small modification needed when re-installing the floor moldings.

A method of installing a multi-layer insulative construction material may comprise the steps of removing window, door, floor and ceiling moldings from a room surface, and then removing all the electrical plates and any other protruding surfaces. Once the surfaces are ready, the installer will install the multi-layer insulative construction material of the present invention over the existing wall by fastening the multi-layer insulative construction material with a fastening means such as adhesive or any mechanical fastening means. After the walls and ceiling are covered with the new material, the installer will have to go back and cut out anything necessary and install new depth modified electrical junction boxes and window/door moldings to accommodate the new thickness of the wall. Then, he can begin finishing the walls with appropriate finishing techniques, such as mudding the drywall and painting the surface. Once that is completed, then he can electrically connect the electrical outlets. If the aspect of the multi-layer insulator material with cavity sections has been used, then the installer will begin spraying foam in insulation between the electrical junction boxes and window/door moldings to make a tight seal.

The various components and aspects in accordance with the method portion of my invention includes some or all of the steps including first removing all moldings, such as door jam moldings and window moldings, among others, from the room where my invention is to be installed, and removing of all electrical outlet plates. The next step is to remove any other fixture that would prevent one from installing a new layer of insulative material over the existing wall or ceiling. Then, once all the wall and/or ceiling surfaces are recovered with the new multi-layer insulative material sheets, then the method includes steps of re-sizing and then re-attaching all the moldings. Some of the moldings will need to be my special molding configuration, as described hereinabove, and some of the moldings, like a crown molding, will need to be cut down slightly to compensate for using up some of the room's dimension, and then re-attached.

What is claimed is:

1. A multi-layer insulative construction material, comprising:
at least one layer of drywall having a front side intended to face the interior of a room and a back side which will be adhered to a second layer of material;
an adhesive layer selected from the group consisting of spray on adhesive, roll-on adhesive, brush-on adhesive, dipping adhesive, and any combination thereof; and
at least one layer of insulation material,
whereby an insulative construction material is made that is capable of being installed over an existing wall to increase the insulative value of the wall.

2. The multi-layer insulative construction material of claim 1, further comprising a sound deadener material adhered to the layer of insulation material.

3. The multi-layer insulative construction material of claim 1, further comprising a fire retardant material adhered to the layer of drywall.

4. The multi-layer insulative construction material of claim 1, further comprising a cavity incorporated into the insulation material layer, said cavity being sized and adapted to receive any one of various wiring or HVAC component configurations.

5. The multi-layer insulative construction material of claim 4, further comprising a spray in foam insulation to fill the cavity.

6. The multi-layer insulative construction material of claim 1, further comprising a vapor barrier.

7. A method of installing a multi-layer insulative construction material, comprising:
removing moldings from a room interior surface;
removing electrical plates and protruding surfaces;
installing a multi-layer insulative construction material over the existing wall;
fastening the multi-layer insulative construction material with a fastening means;
installing new depth modified electrical junction boxes and window/door moldings to accommodate the new thickness of the wall; and
finishing the walls with appropriate finishing techniques.

8. The method of installing a multi-layer insulative construction material of claim 7, further comprising mudding the drywall and painting the surface.

9. The method of installing a multi-layer insulative construction material of claim 7, further comprising electrically connecting the electrical outlets.

10. The method of installing a multi-layer insulative construction material of claim 7, further comprising spraying foam in insulation between the electrical junction boxes and window/door moldings to make a tight seal.
